(19) United States
(12) Patent Application Publication
(10) Pub. No.: US 2008/0099665 A1
(43) Pub. Date: May 1, 2008

(54) VEHICLE PANEL WITH INTEGRAL SENSOR

(76) Inventor: Dimitri Baudon, White Lake, MI (US)

Correspondence Address: KAPLAN GILMAN GIBSON & DERNIER L.L.P., 900 ROUTE 9 NORTH, WOODBRIDGE, NJ, 07095, US

(21) Appl. No.: 11/555,217

(22) Filed: Oct. 31, 2006

(51) Int. Cl. G06M 7/00

(52) U.S. Cl. 250/221

(57) ABSTRACT

A proximity/motion sensor is formed so as to be integral with an interior vehicle panel, such as a dashboard, in which it is provided. Preferably, the sensor is molded behind a transparent or translucent portion of the panel and is sealed inside a plastic material. Preferably, the sensor is an infrared (IR) sensor which receives light from the interior of the vehicle.

### BACKGROUND OF THE INVENTION

The present invention relates generally to motion and proximity sensors, and more particularly, concerns a panel for the interior of a vehicle which includes integral proximity and/or motion detectors, as well as a method for manufacturing such a panel.

A modern automotive vehicle has a multitude of electrically operated devices provided for the comfort and safety of drivers and passengers. These include lights, window and seat controls, air conditioning, heat, and entertainment (e.g., a radio and CD player). In general, such devices are operated by a manual switch. Operation of such a switch by a vehicle operator usually requires him to take his eyes off the road momentarily, especially when a number of switches are located in close proximity and he must be sure that he is operating the correct switch. Accordingly, switches have been provided in the interior of a vehicle which sense the proximity or movement of a part of the operator's body rather than requiring direct manual operation, allowing their operation without viewing them. The elimination of manual switches and the associated moving parts also increases the reliability and operative lifetime of the switches, making them operational essentially for the lifetime of the vehicle.

However, mounting proximity and movement sensitive switches in an interior panel of a vehicle is labor intensive, and the mounting must be of sufficient quality to ensure that the sensors are not damaged and do not deteriorate as a result of environmental contamination, as by dirt or moisture. The need for this quality of mounting also increases the expense of providing such detectors.

### SUMMARY OF THE INVENTION

In accordance with one aspect of the present invention, a proximity/motion sensor is formed so as to be integral with a vehicle panel, such as a dashboard, in which it is provided. Preferably, the sensor is behind a transparent or translucent portion of the panel and is sealed inside a plastic material. Preferably, the sensor is an infrared (IR) sensor which receives light from the interior of the vehicle.

In accordance with another aspect of the present invention, a method is providing for manufacturing a sensory interior vehicle panel having at least one sensor assembly which is integral with the panel. According to the method, a substrate defining at least a portion of the vehicle panel is inserted into an injection tool. An IR sensor is then placed into the injection tool and upon the substrate. Injection material is then introduced into the injection tool so as to integrally mold the IR sensor with the substrate, simultaneously providing mechanical support for the substrate.

In accordance with another aspect of the present invention, the integral sensor is provided with a wireless power connection, affording improved sealing and protection of the sensor. A miniature secondary coil is formed with the sensor so as to provide electrical power thereto, the secondary coil being sealed along with a sensor. A primary coil is provided within the vehicle in close proximity to the location of the secondary coil when the panel is mounted. The sensor can then be powered by powering the primary coil, inducing a signal in the secondary coil which can then be used to power the sensor.

### BRIEF DESCRIPTION OF THE DRAWINGS

The foregoing brief description, as well as further objects, features, and advantages of the present invention will be understood more completely from the following detailed description of presently preferred, but nonetheless illustrative, embodiments in accordance with the present invention, with reference being had to the accompanying drawings, in which:

FIG. 1 is a schematic diagram of a panel 10 embodying the present invention;

FIG. 2 is a schematic representation of a process for manufacturing a panel 10 in accordance with an embodiment of the present invention;

FIG. 3 is a schematic representation of the method of manufacturing an alternate embodiment of a panel in accordance with the present invention; and

FIG. 4 is a circuit schematic diagram showing the circuit makeup of coil assembly 40.

### DETAILED DESCRIPTION OF THE PREFERRED EMBODIMENTS

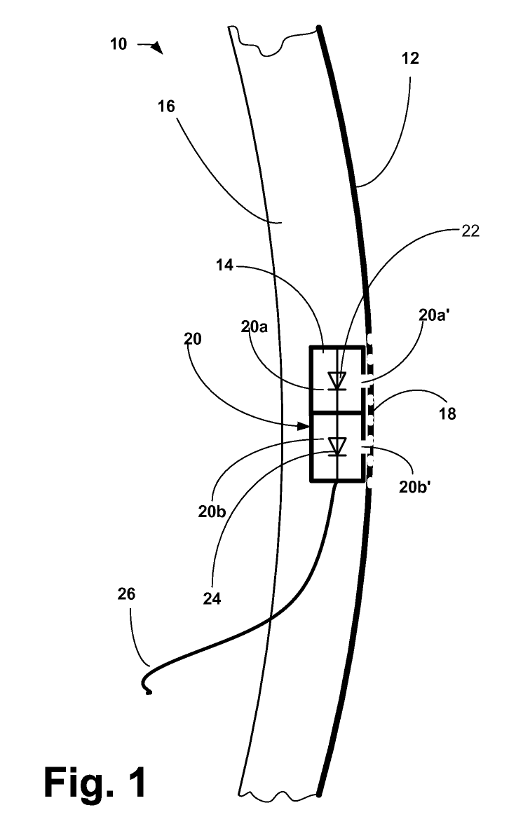

Turning now to the drawings, FIG. 1 is a schematic diagram of a panel 10 embodying the present invention. Panel 10 is preferably an automotive dashboard or a portion of a dashboard. Panel 10 broadly comprises a substrate 12, a layer of plastic material 16 formed on the back of the substrate, and a sensor 14 embedded in and sealed by the material 16, securing in behind the substrate.

Substrate 12 defines the decorative surface of panel 10 as seen from the interior of the vehicle. Preferably, substrate 12 is a polycarbonate film with a decorative film ink finish, such as a serigraph film. In front of the sensor 14, the film 16 is preferably removed to provide a transparent or translucent window 18 for the sensor 14.

Sensor 14 is mounted on the back of substrate 12 in alignment with the window 18. Sensor 14 preferably has a housing 20 with compartments 20a, 20b, the compartments having respective windows 20a′ and 20b′, which face the window 18 in substrate 12. Within compartment 20a, there is mounted a light emitting diode (LED) 22, and within compartment 20b there is mounted a light detector 24. Preferably, LED 22 emits infrared light, and detector 24 detects infrared light. Emitters and detectors of infrared light are well known to those skilled in the art and are widely used, for example, in remote controls of the type which operate television sets.

A “pigtail” 26 projects from housing 20 and provides all the electrical connections necessary to power sensor 14 and to communicate any signal produced thereby outside of the panel 10. Behind substrate 12 and surrounding housing 20, there is provided a layer 16 of plastic material within which sensor 14 is sealed, with only the pigtail 26 projecting.

Preferably, layer 16 extends rearward from substrate 12 for approximately 3-4 millimeters providing mechanical support thereto. If layer 16 is injection molded over substrate 12, as described further below, it may be made of polypropylene, acrylonitrile butadiene styrene (ABS), polycarbonate acrylonitrile butadiene styrene (PCABS), or translucent polycarbonate (PC), ABS or acrylonitrile styrene acrylate (ASA).

In practice, panel 10 may be preformed with a desired pattern of sensors 14, a single sensor being shown only for convenience of description. In operation, LED 22 will emit radiation through windows 20a′ and 18 to the interior of the vehicle. In the absence of an occupant or object, the radiation will merely be radiated into the vehicle. However, when an occupant or object is within a predefined range, the radiation emitted by LED 22 will be reflected from the occupant or object and will enter through windows 18 and 20b′ into compartment 20b. This radiation will cause detector 24 to produce an electrical signal, which may be sensed remotely from panel 10 via pigtail 26. Those skilled in the art will appreciate that sensor 14 may be used as a proximity detector by producing an alarm when the signal produced by detector 24 exceeds a predefined level. Alternately, changes in the value of the signal produced by detector 24 may be sensed in order to detect movement of an occupant or object.

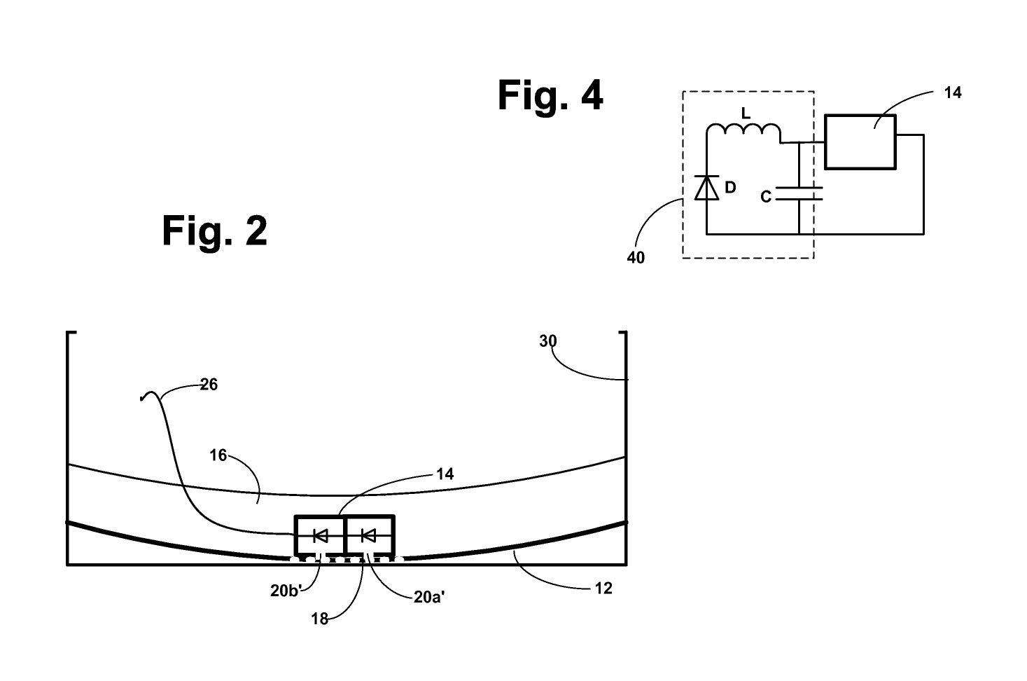

FIG. 2 is a schematic representation of a process for manufacturing a panel 10 in accordance with an embodiment of the present invention. Initially, a substrate film 12 is formed in the desired shape of the panel and placed within a molding tool 30. In FIG. 2, the exterior or front surface of the panel is the bottom surface and the interior or rear surface is the top surface. Preferably, substrate 12 is a polycarbonate (PC) film and it may have a finish formed on its exterior or interior surface, as by printing. Also, it includes a clear or translucent portion or window 18. After film 12 is introduced in molding tool 30, the sensor 14 is placed upon the film 12 with its windows 20a′ and 20b′ in registry with window 18 of substrate 12. Sensor 14 may be obtained from known suppliers.

Thereafter, a plastic material 16 is injection molded over substrate 12 and sensor 14, preferably to a depth of 3-4 millimeters. The injection molded plastic material may be a matrix of polypropylene (PP), acrylonitrile butadiene styrene (ABS), polycarbonate acrylonitrile butadiene styrene (PCABS), or translucent polycarbonate (PC), ABS or acrylonitrile styrene acrylate (ASA). When the material of layer 16 is cured, it bonds to the rear surface of substrate 12 and substantially surrounds sensor 14, effectively sealing it, with only pigtail 26 protruding. The result is a panel with a desired finish and an embedded or integral sensor 14 behind a window 18, as illustrated in FIG. 1.

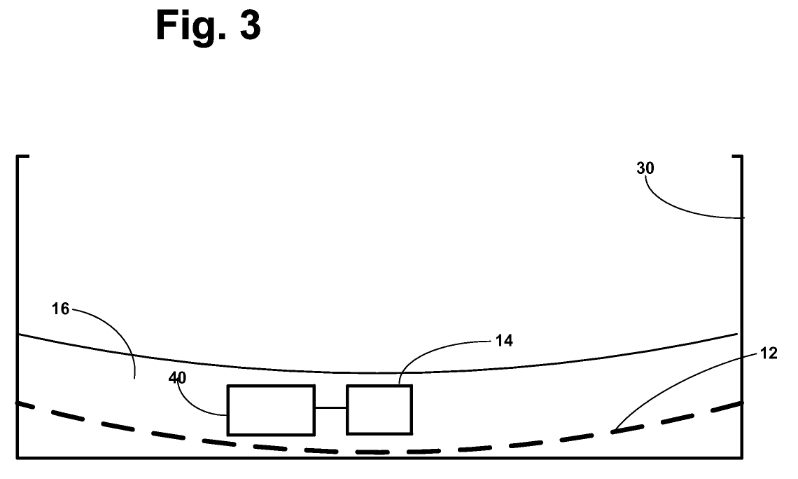

FIG. 3 is a schematic representation of a method for manufacturing an alternate embodiment of a panel in accordance with the present invention. In this case, a sensory panel is made which contains an embedded sensor 14 with power provided wirelessly. As was the case previously, a polycarbonate film 12 is provided in the molding tool 32. Preferably, the film 12 has a finish on its exterior (or interior) surface. A central portion of film 12 is unfinished in order to provide a window 18 for sensor 14.

A sensor 14 with an induction coil module 40 connected thereto is placed upon the film 12. As in the embodiment of FIG. 2, windows 20a′ and 20b′ in module 14 are aligned with the window 18 in film 12. The module 40 is provided in order to power sensor 14 wirelessly, as will be explained further below. As is known by those skilled in the art, provision could also be made for wireless transmission of the signal from sensor 14, as by IR.

On top of elements 40 and 14, the layer 16 of material is injection molded so that, when cured, it bonds to the top surface of the film 12 and embeds and surrounds the sensor 14 and the coil assembly 40, effectively sealing in the elements 14 and 40.

The resulting panel will have the same appearance as the panel of FIG. 1, except there will be no pigtail if the signal from sensor 14 is communicated wirelessly. This panel may be powered by bringing a transmitting coil (not shown) into the vicinity of coil assembly 40. A voltage is then induced in coil assembly 40. FIG. 4 is a circuit schematic diagram showing the circuit makeup of coil assembly 40. In order to make use of the induced voltage to power sensor 14, the induced voltage is rectified. The rectifying circuitry constitutes a diode D and a capacitor C, with the powering voltage to module 40 being provided across the inductor I. It will be appreciated that the diode and capacitor will be sealed along with the inductor 42 as induction module 40.

As shown in FIG. 4, the voltage induced in inductor 42 charges capacitors C through diode D when diode D is conductive. When the induced voltage reverses, diode D turns off and leaves capacitor C charged, with the sensor 14 continuing to be powered from the capacitor.

The panel manufactured as in FIG. 3 has at least one integral, sealed sensor which can be conveniently powered mounting a driving coil so that it is in the vicinity of inductor 42 when the panel is mounted in its position of use.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A sensory panel, comprising:
a plastic body disposed in a vehicle and constituting at least a portion of a panel forming part of the vehicle, the body having a first face directed into an interior of said vehicle; and
a radiant energy sensor integral with said plastic body and constructed to receive radiant energy from the interior of said vehicle.

2. The sensory panel of claim 1 wherein said sensory panel is at least part of a panel in a passenger compartment of the vehicle.

3. The sensory panel of claim 2 wherein said panel in the passenger compartment is a dashboard.

4. The sensory panel of claim 1, wherein a portion of said first face is constructed to transmit the radiant energy sensed by said radiant energy sensor.

5. The sensory panel of claim 1, wherein said sensor is constructed to sense infrared radiation.

6. The sensory panel of claim 5, wherein said sensor is embedded and enclosed in said body.

7. The sensory panel of claim 6, wherein said sensor includes an enclosure containing an infrared energy detector, said enclosure having an infrared energy transmissive window between said detector and the vehicle interior, so that infrared energy from within the vehicle may be detected.

8. The sensory panel of claim 7, further comprising an infrared energy radiator disposed in an enclosure in said sensor, the enclosure having an infrared energy transmissive window between said radiator and the vehicle interior, so that energy from said radiator is introduced into the vehicle interior.

9. The sensory panel of claim 1, wherein said sensor is embedded and enclosed in said body.

10. The sensory panel of claim 9, wherein said sensor includes an enclosure containing a radiant energy detector for radiant energy of a predefined wavelength, said enclosure having a window which transmits said predefined wavelength, the window being between said detector and the vehicle interior, so that radiant energy of said wavelength from within the vehicle may be detected.

11. The sensory panel of claim 10, further comprising and energy radiator of said predefined wavelength disposed in an enclosure in said sensor, the enclosure having a window which transmits energy of said predefined wavelength, said window being disposed between said radiator and the vehicle interior, so that energy from said radiator is introduced into the vehicle interior.

12. The sensory panel of claim 1 wherein said sensor is constructed to receive radiant energy reflected from an object or person within the vehicle, whereby said sensor is operative to detect at least one of: the presence and the motion of the object or person.

13. The sensory panel of claim 1, further comprising an inductor connected to said sensor and also integral with the body.

14. The sensory panel of claim 13, wherein the inductor is positioned to be adjacent another inductor when the panel is mounted in the vehicle, so that the other inductor may induce a signal therein.

15. A method for manufacturing a sensory panel, comprising:
inserting a film substrate into a molding tool for forming at least a portion of a vehicle panel;
placing a radiant energy sensor adjacent said film substrate in said molding tool so as to sense radiant energy passing through said film substrate; and
introducing a moldable material into said molding tool to integrally mold the sensor with the film substrate to form the portion of the vehicle panel.

16. The method of claim 15 wherein the vehicle panel is a dashboard thereof

17. The method of claim 15 wherein said radiant energy sensor is an infrared energy sensor.

18. The method of claim 15 wherein said molding tool is an injection molding tool and the moldable material is injected into said tool.

19. The method of claim 15 wherein said moldable material is introduced so that the sensor is embedded and enclosed therein.

20. The method of claim 15, wherein said placing step includes connecting an induction coil to the radiant energy sensor and placing it together with the sensor.
